(19) United States
(12) Patent Application Publication
(10) Pub. No.: US 2025/0083766 A1
(43) Pub. Date: Mar. 13, 2025

(54) BICYCLE TRAILERS

(71) Applicant: Arthur PETERS, Gravesend, Kent (GB)

(72) Inventor: Arthur PETERS, Gravesend, Kent (GB)

(21) Appl. No.: 18/292,510

(22) PCT Filed: Jul. 28, 2022
(86) PCT No.: PCT/GB2022/051983

§ 371 Date: Jan. 26, 2024

(30) Foreign Application Priority Data
Jul. 28, 2021 (GB) 2110874.1
Jul. 28, 2021 (GB) 2110875.8

(51) Int. Cl. B62K 27/12

(52) U.S. Cl. CPC B62K 27/12

(57) ABSTRACT

A bicycle carrier for towing a second bicycle behind a first bicycle is provided. A carrier base has carrier wheels and is adapted to carry a wheel of the second bicycle. The carrier base is articulated to arms at their ends remote from the rear hub of the first bicycle. Clamping means are provided for clamping the wheel of the second bicycle in place on the base. The base can be carried above a rear wheel of the first bicycle when the carrier is not in use. A passenger carrier for a bicycle includes a carrier base having wheels, and handlebars on a member attached to the carrier base and foldable with respect thereto. Side sections of the base are locatable within a footprint of the central section when the carrier is not in use.

### BACKGROUND TO THE INVENTION

This invention relates to trailers for bicycles with improved functionality.

### SUMMARY OF THE INVENTION

From a first aspect, the invention seeks to provide an arrangement for towing one bicycle stably behind another, the towed bicycle being of any reasonable size.

The first aspect of the invention provides a bicycle carrier for towing a second bicycle behind a first bicycle, the bicycle carrier comprising first and second arms for pivotal attachment to a wheel-carrying part of the first bicycle, a carrier base having carrier wheels and adapted to carry a wheel of the second bicycle, the carrier base being articulated to the first and second arms at ends thereof remote from the pivotal attachment, clamping means for clamping the wheel of the second bicycle in place on the base, the base being securable to a frame of the first bicycle such that the base can be carried above a rear wheel of the first bicycle when the carrier is not in use.

The clamping means comprise a clip and a spring arranged to urge the clip against the wheel of the second bicycle. Alternatively, the clamping means can comprise members arranged at an acute angle to each other, between which the wheel of the second bicycle can be inserted and clamped.

At least one strut pivotable with respect to the base may be provided for securing the base to a frame of the second bicycle. The strut may be foldable against the base. A pair of such struts may be provided with jaws for clamping the frame of the second bicycle.

The first and second arms may be telescopic and may be articulated to the base via a transverse bar.

The carrier can be provided with lateral axle extensions for extending axles of the carrier wheels to provide a stabilising effect. Additionally, the carrier can be provided with axle bars mountable to the base in a vertical orientation, so that axles of the carrier wheels are elevated with respect to the base.

In an embodiment of the invention, the base is detachable from the arms to allow the interchangeable attachment of other kinds of carrier or trailer or a stabiliser.

The base may be formed of at least two parts, the parts being slidable longitudinally relative to each other to vary a length of the base.

It is an aim of a second aspect of the invention to provide a collapsible carrier for an additional passenger to be towed by a bicycle.

The second aspect of the invention provides a passenger carrier for a bicycle, the carrier comprising first and second arms for pivotal attachment to a wheel-carrying part of the bicycle, a carrier base having wheels, the carrier base being articulated to the first and second arms at ends thereof remote from the pivotal attachment, and handlebars on a member attached to the carrier base and foldable with respect thereto, the base being securable to a frame of the bicycle such that the base can be carried above the rear wheel of the bicycle when the carrier is not in use, the base comprising a central base section and first and second side sections to which the wheels can be attached, the first and second side sections being locatable within a footprint of the central section when the carrier is not in use.

In embodiments of the second aspect of the invention, the wheels are detachable from the base. The wheels may be mountable on axles that are foldable into recesses on the base when the wheels are detached.

The member for the handlebars may be telescopic.

A seat for a passenger can be provided on a member attachable to the base and foldable with respect thereto or detachable therefrom.

In an embodiment of this aspect of the invention, the base is detachable from the arms to allow the interchangeable attachment of other kinds of carrier or trailer or a stabiliser.

### BRIEF DESCRIPTION OF THE DRAWINGS

Embodiments of the invention will now be described in more detail, by way of example only, with reference to the accompanying drawings, in which:

FIG. 1 shows a carrier according to the invention, in a stowed position on a first bicycle;

FIG. 2 is a perspective view of the carrier in the stowed position;

FIG. 3 shows the carrier in the unfolded position;

FIG. 4 shows pivotable struts with jaws for clamping the frame of the second bicycle;

FIG. 5 shows the carrier in use;

FIG. 6 shows a version of the carrier having alternative clamping means;

FIG. 7 shows a lateral axle extension;

FIG. 8 shows the carrier with lateral axle extensions;

FIG. 9 shows a vertical axle extension;

FIG. 10 shows the carrier with vertical axle extensions;

FIG. 11 shows a carrier according to the second aspect of the invention, attached to a bicycle;

FIG. 12 shows the carrier of FIG. 8, with a seat attached;

FIG. 13 is a fragmentary view of the carrier;

FIG. 14 shows the base of the carrier in the collapsed position; and

FIG. 15 shows the carrier in the stowed position on the bicycle.

### DETAILED DESCRIPTION OF PARTICULAR EMBODIMENTS

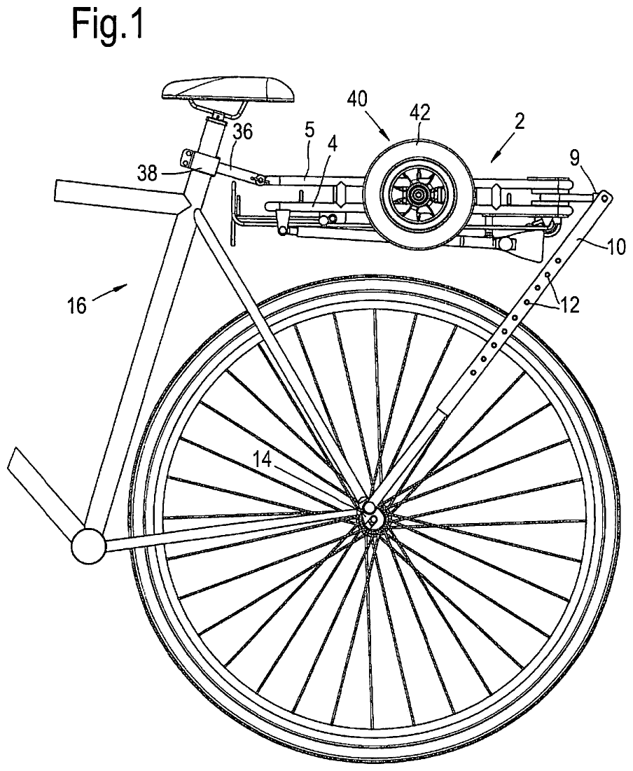

FIGS. 1 to 5 show a cycle carrier comprising an elongate base 2, formed from first and second aligned, generally rectangular frame elements 4, 5. The frame element 4 which is the upper one when the carrier in use includes aligned V-shaped rests 6.

This frame element 4 includes two generally parallel support arms 7 extending along the frame element 4.

At one end, the base 2 is connected to a transverse bar 9 with a movable connection, for example a ball and socket joint. This bar is articulated at its ends to two arms 10. The arms are telescopic and can be fixed at different lengths by sprung buttons engageable in holes 12 in a known manner.

At their other ends, the arms 10 are attached to either side of a rear hub 14 of a first bicycle 16. The arms are rotatable about this point with a locking rotational mechanism, in this example a dog clutch 17.

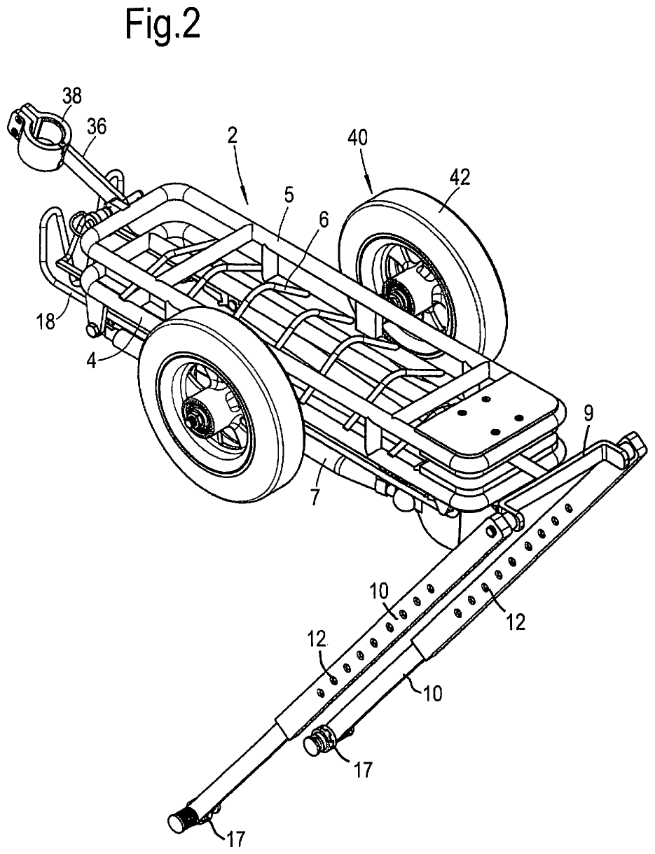

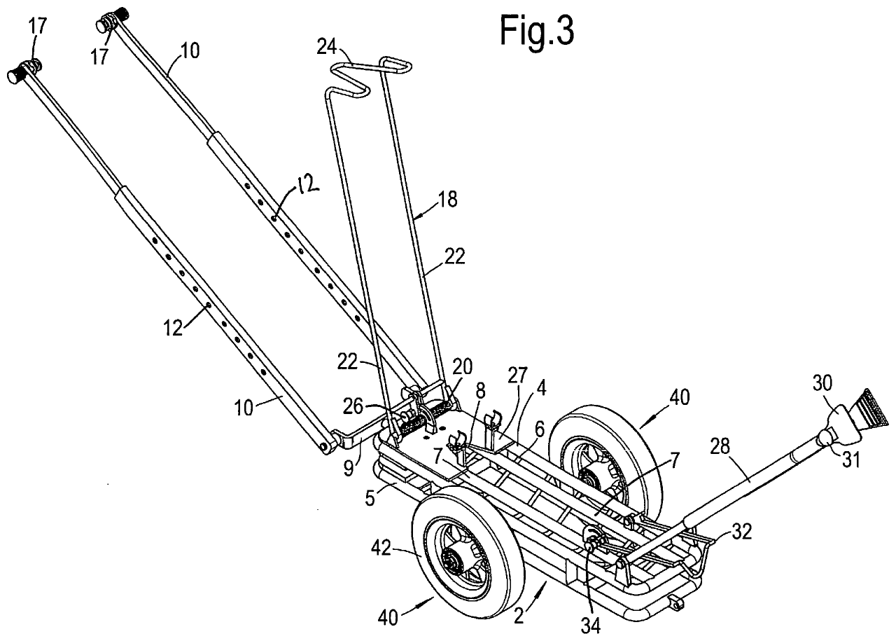

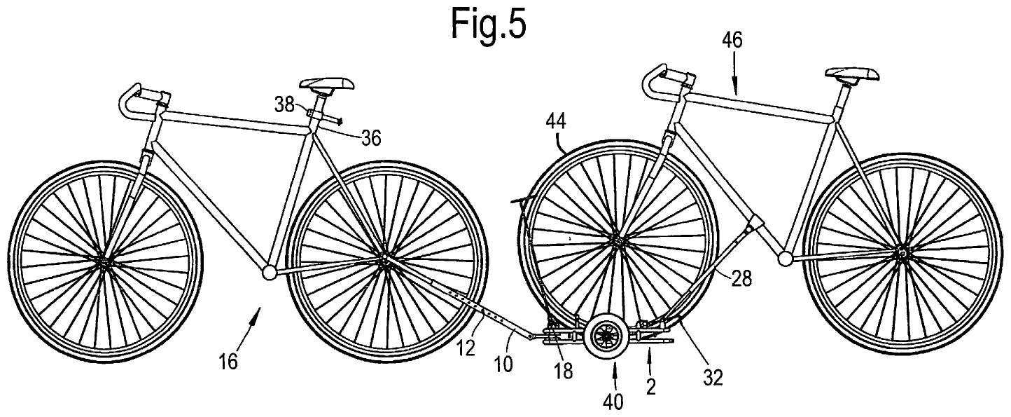

A spring clip 18 is provided at the end of the base 2 connected to the bar 9. The clip 18 pivots with respect to the base 2 but is urged towards the base by a spring 20. The clip comprises legs 22 and a central part 24, which in this example is W-shaped. An index bolt 26 is provided to hold the clip 18 in either its stowed position, shown in FIGS. 1 and 2, or its deployed position, shown in FIGS. 3 and 5.

At the same end of the base 2 is a plate 27 with a V-shaped notch 8.

A pair of struts 28 is pivotable with respect to the base 2 at its end remote from the clip 18. Clamping jaws 30 are provided at the free end of the struts 28. These jaws can be tightened by means of a spring loaded screw 31 which connects the struts 28 together.

A secondary, generally U-shaped clip 32 is pivotable with respect to the base 2 at a point near the strut and can be held at stowed or deployed positions by an index bolt 34.

At the same end as the strut 28, a link 36 is detachably connected to the base 2. At the end free end of the link 36 is a collar 38.

Wheels 40 are provided on either side on axles on the base 2, preferably having solid rubber tyres 42.

FIGS. 1 and 2 show the cycle carrier in its stowed position. The spring clip 18, struts 28 and secondary clip 32 are all folded flush with the base 2. This is located above a rear wheel of the first bicycle 16. The base 2 is attached to either the seat stem or the frame of the first bicycle 16 by means of the collar 38. In this position, the base 2 can be used to carry goods.

In order to deploy the carrier, the link 36 is detached from the base 2, the arms 10 are moved downwardly and the base 2 is unfolded so that the wheels 40 are on the ground. The clips 18, 32 and the struts 28 are then unfolded. The front wheel 44 of a second bicycle 46 is then placed into the rests 6 and the notch 8 and held in place by the clips 18, 32. The struts 28, one on each side of the wheel of the second bicycle, are then attached to the frame of the second bicycle 46 by means of the jaws 30.

The two bicycles are then as shown in FIG. 5. In this configuration the first bicycle can be used to tow the second bicycle, which may or may not have a rider. If a rider of the second bicycle pedals, the two bicycles effectively form a tandem.

The carrier of the invention can tow a second bicycle regardless of the size of the wheel or frame of that second bicycle. Whilst FIG. 5 shows the front wheel of the second bicycle clamped within the carrier, the rear wheel could alternatively be so clamped, for example if that wheel was damaged, with the second bicycle pointing in the opposite direction to the first bicycle.

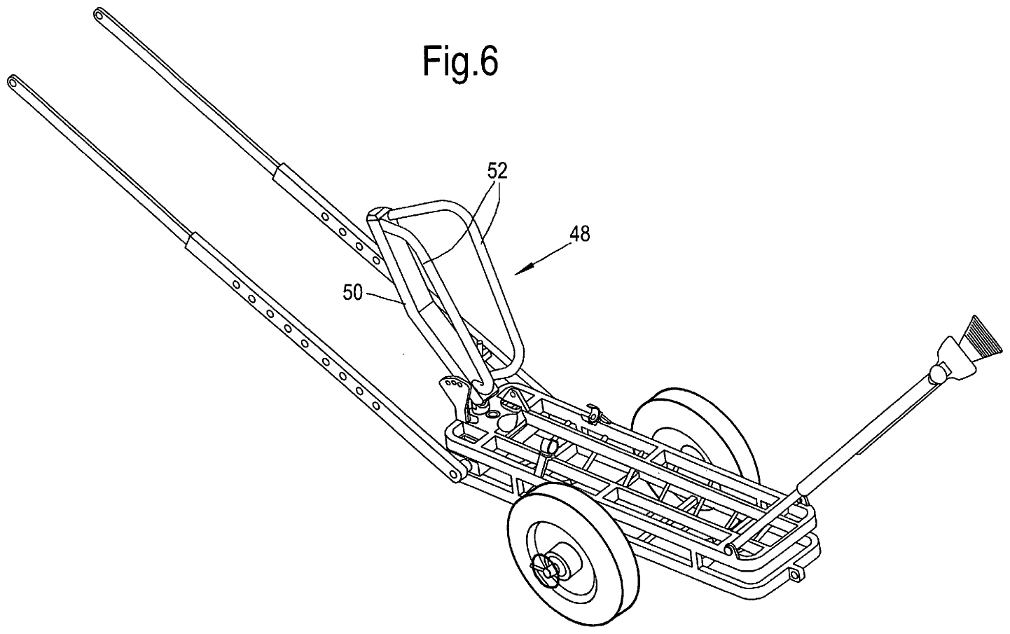

FIG. 6 shows a carrier in which the spring clip 18 is replaced by a rest 48 having an angled central part 50. Generally U-shaped wings 52 extend from the central part 50 at an acute angle to each other. The front or rear wheel of the second bicycle can be inserted and clamped between the wings 52.

An alternative to the fixed size base 2 is to form the base in at least two parts which slide longitudinally, telescopically with respect to each other. Such a base can be provided with a spring to urge the parts towards each other. In this way the carrier allows bicycles having wheels of a larger range of sizes to be towed.

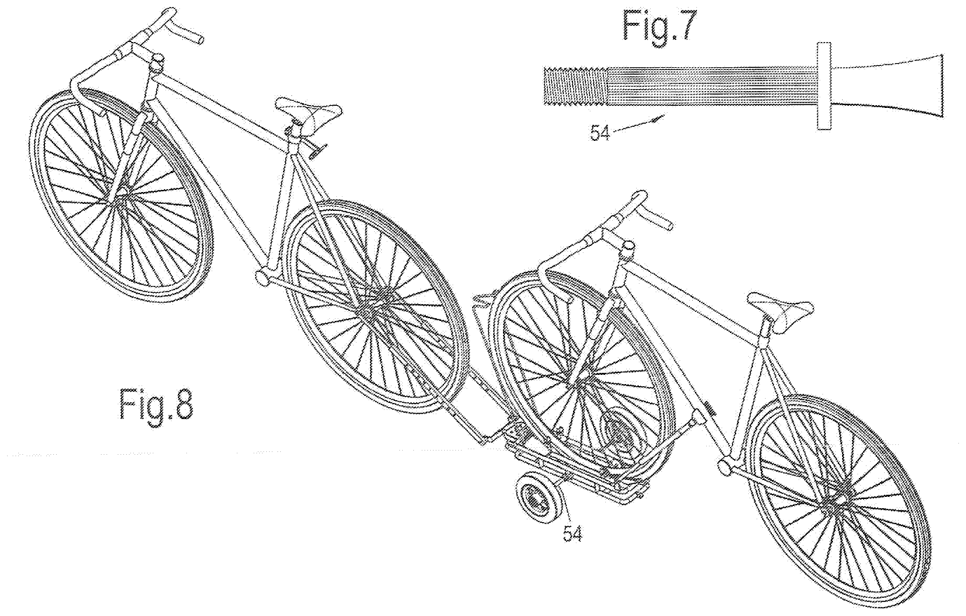

FIGS. 7 and 8 shows how axle extenders 54 can be used to extend the axles of the wheels 40 and enhance the stability of the combined bicycles.

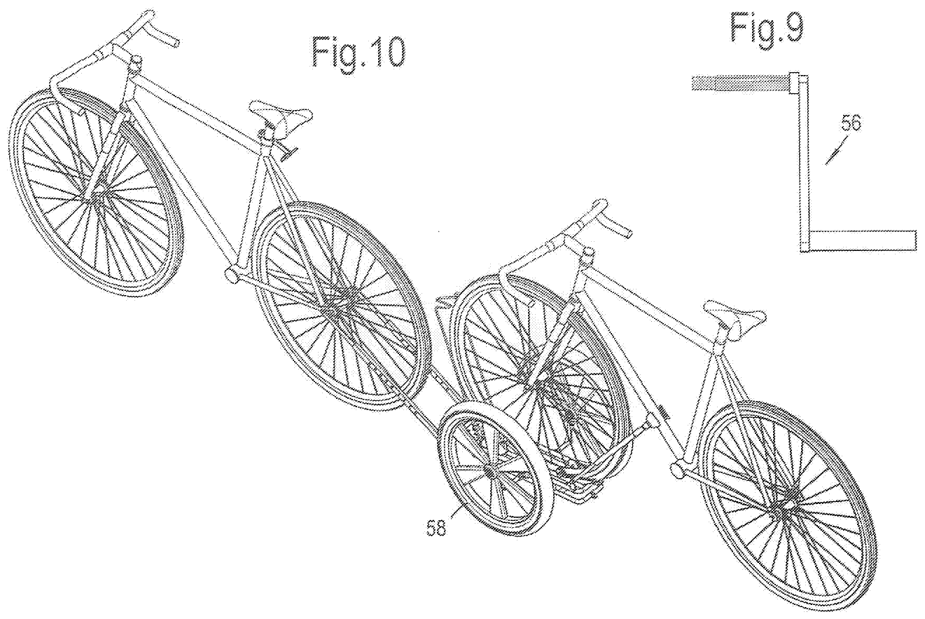

FIG. 9 shows a vertical axle extension bar 56 which can be fitted to the base 2. As shown in FIG. 10, this allows the carrier to be fitted with larger wheels 58 for even greater stability.

The base 2 can be detachable from the bar 9 to allow the use of the arms 10 with units other than a cycle carrier, for example a goods or person carrier or a stabiliser.

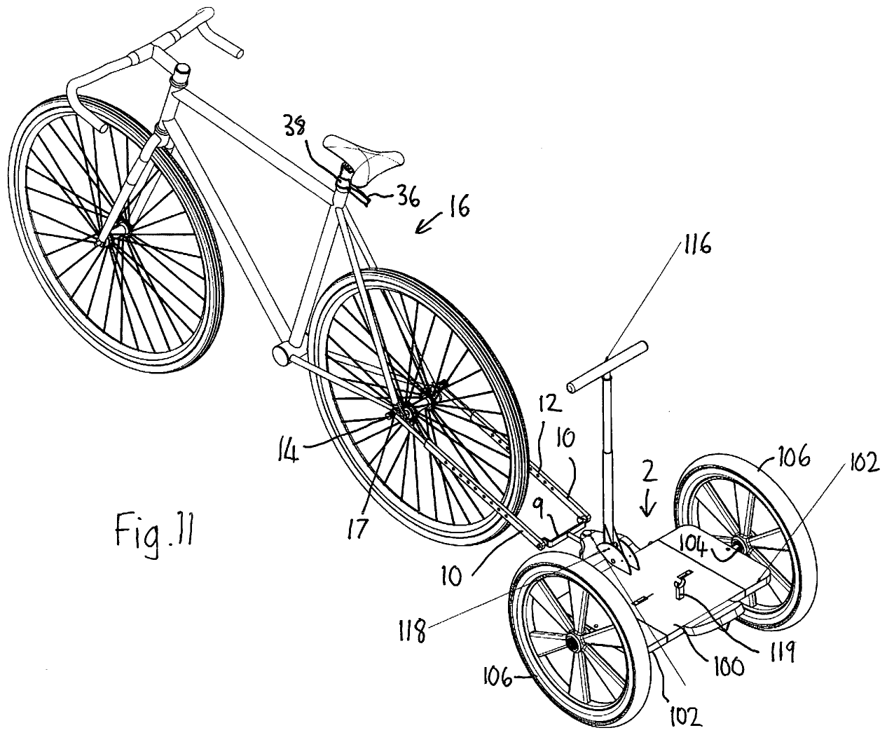

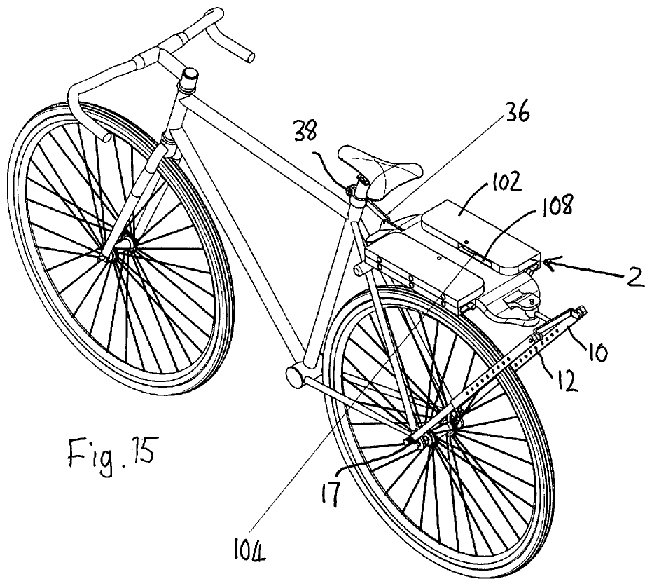

FIGS. 11 to 15 show a passenger carrier comprising a generally planar base 2, divided into a rectangular central section 100, and side sections 102. Each of the side sections carries an axle 104 having a wheel 106. The wheels are detachable from the axles 104, which are then pivotable into recesses 108 in the side sections 102.

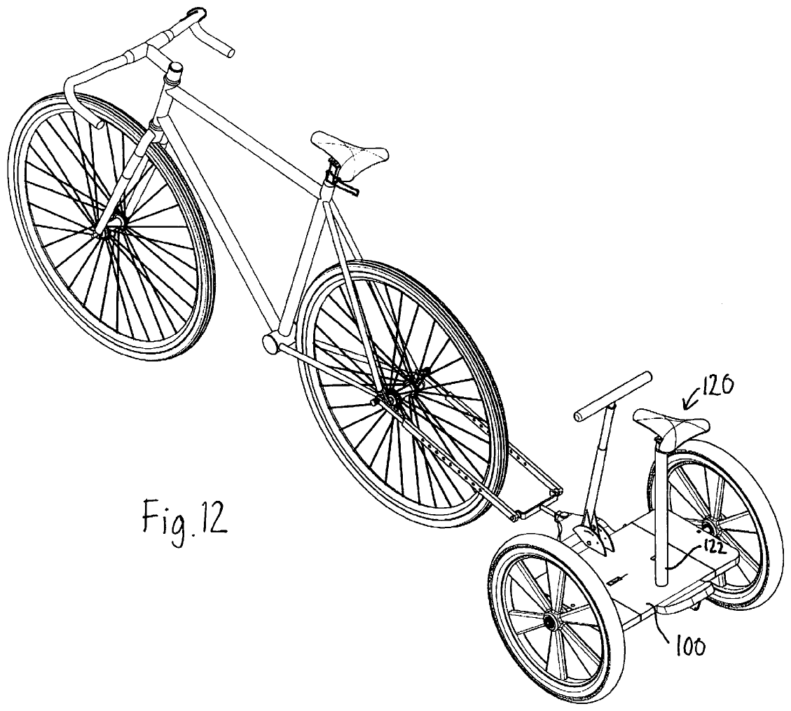

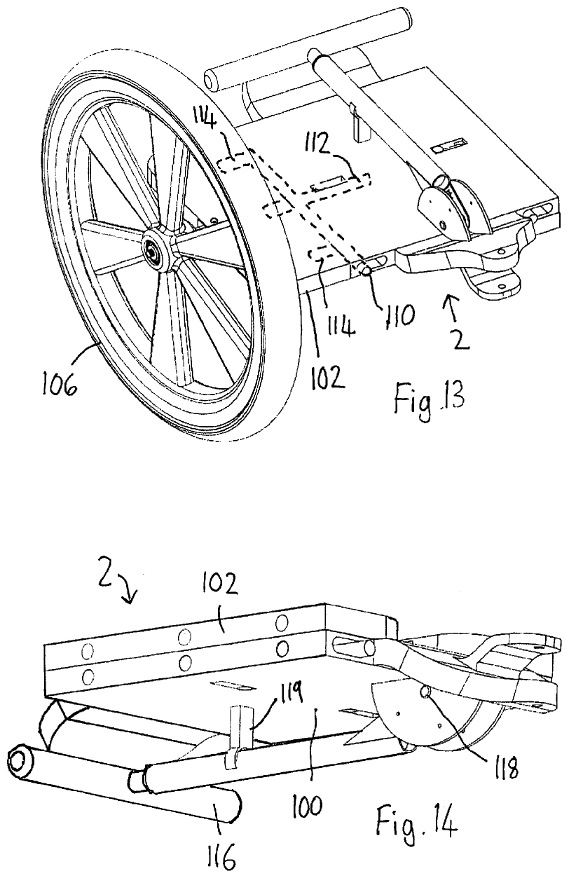

As shown in FIG. 13, the side sections 102 are each kept in place by a trident-shaped member 110 which has a bar 112 extending into a slot in the central section 100, and three prongs 114 extending into holes in the side section 102. The member 110 can be moved inwardly within the central section 102, which disengages the prongs 114. The side sections 102 can then be folded to the position shown in FIGS. 11 and 12.

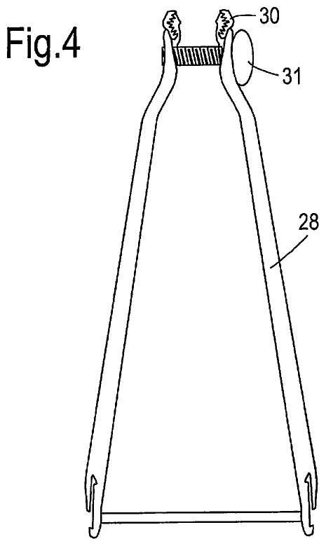

A handlebar member 116 is mounted on the base 2. The handlebar member is telescopic to adjust its height. The handlebar member is foldable with respect to the base 2 and can be retained in both a stowed and a deployed position by an index bolt 118. In the stowed position, as shown in FIG. 4, the handlebar member is secured by a clip 119.

FIG. 12 shows a removable seat arrangement 120 including a height-adjustable post 122 which can be mounted on a protrusion or in an indent (not shown) at the rear of the central section 100.

At one end, the base 2 is connected to a transverse bar 9 with a movable connection, for example a hinge. This bar is articulated at its ends to two arms 10. The arms are telescopic and can be fixed at different lengths by sprung buttons engageable in holes 12 in a known manner.

At their other ends, the arms 10 are attached to either side of a rear hub 14 of a bicycle 16. The arms are rotatable about this point with a locking rotational mechanism, in this example a dog clutch 17.

The carrier of the invention allows two people to share a bicycle. One pedals the bicycle and the other is carried, either standing, in the configuration shown in FIG. 11, or seated, in the configuration shown in FIG. 12. The side sections 102 allow more space for the passenger's feet.

When the carrier is not being used to carry a passenger, it can be stowed. The wheels 106 and the optional seat member 120 are removed. The handlebar member 116 is folded against the base 2 and the base is collapsed as described above. The arms 10 are then rotated, and the base moved to the position shown in FIG. 5, where it is detachably connected to a link 36 secured to a seat stem of the bicycle 16 by means of a collar 38. In this position, the base 2 can be used to carry a load.

1. A bicycle carrier for towing a second bicycle behind a first bicycle, the bicycle carrier comprising:
first and second arms for pivotal attachment to a wheel-carrying part of the first bicycle,
a carrier base having carrier wheels and adapted to carry a wheel of the second bicycle, the carrier base being articulated to the first and second arms at ends thereof remote from the pivotal attachment, and
a clamping arrangement including at least one elongate member attached to the carrier base for clamping the wheel of the second bicycle in place on the base,
the base being securable to a frame of the first bicycle such that the base can be carried above a rear wheel of the first bicycle when the carrier is not in use.

2. The bicycle carrier according to claim 1, wherein the clamping arrangement comprises a clip and a spring arranged to urge the clip against the wheel of the second bicycle.

3. The bicycle carrier according to claim 1, wherein the at least one elongate member comprises first and second elongate members arranged at an acute angle to each other, between which the wheels of the second bicycle can be inserted and clamped.

4. The bicycle carrier according to claim 1, wherein the at least one elongate member is at least one strut pivotable with respect to the base for securing the base to a frame of the second bicycle.

5. The bicycle carrier according to claim 4, wherein the at least one strut is foldable against the base.

6. The bicycle carrier according to claim 4, including two of said struts, provided with jaws for clamping the frame of the second bicycle.

7. The bicycle carrier according to claim 1, wherein the first and second arms are telescopic.

8. The bicycle carrier according to claim 1, wherein the first and second arms are articulated to the base via a transverse bar.

9. The bicycle carrier according to claim 1, including lateral axle extensions for extending axles of the carrier wheels.

10. The bicycle carrier according to claim 9, including axle bars mountable to the base in a vertical orientation, so that the axles of the carrier wheels are elevated with respect to the base.

11. The bicycle carrier according to claim 1, wherein the base is detachable from the arms.

12. The bicycle carrier according to claim 1, wherein the base comprises at least two parts, slidable longitudinally with respect to each other to adjust the size of the base.

13-18. (canceled)
